(19) United States
(12) Patent Application Publication
(10) Pub. No.: US 2010/0050525 A1
(43) Pub. Date: Mar. 4, 2010

(54) Revolving Door

(75) Inventor: Peter Blasi, Mahlberg (DE)

Correspondence Address: GUDRUN E. HUCKETT DRAUDT, SCHUBERTSTR. 15A, WUPPERTAL, 42289, DE

(73) Assignee: BLASI-GMBH AUTOMATISCHE TÜRANLAGEN, Mahlberg (DE)

(21) Appl. No.: 12/514,825

(22) PCT Filed: Nov. 14, 2007
(86) PCT No.: PCT/DE07/02050

§ 371 Date: May 14, 2009

(30) Foreign Application Priority Data
Nov. 15, 2006 (DE) 10 2006 053 708.4

(51) Int. Cl. E05F 15/20; E06B 3/90

(52) U.S. Cl. 49/26

(57) ABSTRACT

A revolving door has two opposed concentric drum walls of a cylindrical segment shape. Door leaves are rotatably supported on a central axis. A floor and a ceiling are connected to the drum walls. Sensors monitor completely or partially at least one surface of an inner wall of the drum walls; the door leaves; the floor; and the ceiling with regard to whether an object is located on or at the at least one surface.

The invention concerns a revolving door according to the preamble of claim 1.

Revolving doors are known in many configurations. In addition to manually actuatable revolving doors also those with electric motor drives are known, in particular with a fully automated microprocessor-controlled drive system. The present invention is based on a revolving door of the latter type.

The known revolving doors have externally a stationary drum wall which has two passages that are in general diametrically opposed. These two passages form essentially a lock for the revolving door. Within the round drum wall there is a rotary device comprising in particular a two-leaf turnstile designed such that door leaves extend radially from a central vertical axis. This rotary device is caused to rotate by means of the electric motor so that the door leaves rotate and with their outwardly positioned ends are flush with the inner side of the curved drum wall.

These revolving doors have various monitoring devices in order to control, monitor and ensure with respect to injury to persons a problem-free course of movement of the revolving door, however, monitoring with respect to whether a person drops something on the floor or sticks something to the inner wall of the drum walls or the door leaves or the ceiling is not possible as of yet. For this reason, such a revolving door is watched currently by a guard person.

Based on this it is an object of the invention to provide a revolving door of the aforementioned kind with an automatically operating device that monitors whether a person drops something on the floor or sticks something to one of the surfaces in the interior of the revolving door.

The technical solution is characterized by the features of the characterizing portion of claim 1.

In this way, a revolving door is provided with which there is the possibility to detect automatically whether a person drops an object on the floor or sticks something on the surfaces in the interior of the revolving door. In this way, the safety standard is significantly increased. The basic principle of the invention resides in that all surfaces (or a portion of the surfaces) in the interior of the revolving door are monitored by sensors in regard to whether an object is present within their area. When one of the sensors detects an object, for example, the revolving door stops immediately, moves into a safety position, and triggers a security alarm. As a whole, the inventive system prevents that in security-relevant areas such as airports, persons or even objects can be smuggled in.

The embodiment according to claim 2 proposes that only those sensors will be activated that are located in the area where a person passes from the unsecured side in front of the revolving door to the secured side behind the revolving door.

According to the embodiment of claim 3, particularly photoelectric barriers with senders and receivers can be provided for monitoring. These photoelectric barriers define a grid which extends in the area of the surfaces to be monitored at a relatively minimal spacing parallel thereto. The surfaces are thus essentially covered by the corresponding photoelectric grid. In case of the photoelectric barriers, the senders can be arranged on one side and the receivers on the opposite side. However, it is also conceivable that the light emitted by the senders is returned by reflectors and is then detected by the receivers that are located in the area of the senders. In place of the photoelectric barriers it is also conceivable that the sensors emit light that is reflected by an object and accordingly detected. In the aforementioned context, “light” is to be understood as any type of electromagnetic radiation, i.e., also outside of the visible range. In particular lasers are to be considered as light sources. The use of ultrasound is also conceivable.

The embodiment according to claim 4 discloses a first variant for providing a photoelectric grid. The basic principle resides in that the door leaves are provided radially outwardly with transverse leaves, in the broadest sense, that can be in particular display cabinets. Between these transverse leaves a horizontal grid of photoelectric barriers is generated wherein the light beams are oriented particularly parallel to one another. The sensors detect thus objects which are either lying on the ground or have been stuck to the ceiling.

A further variant is provided by the embodiment according to claim 5. The basic principle resides in that photoelectric barriers are provided that extend from the door leaves radially outwardly in the direction toward the drum walls. In this connection, the senders are arranged on the door leaves. The advantage resides in that by this arrangement and orientation of the photoelectric barriers upon rotational movement of the door leaves the entire floor as well as the entire ceiling are scanned by the photoelectric barriers so that there are no dead zones.

Advantageously, according to the embodiment of claim 6 the light beams of the photoelectric barriers are divergent.

In order to detect objects that have been stuck to the inner side of the drum walls the embodiment according to claim 7 proposes a vertical grid of photoelectric barriers which extends across the curved inner circumference of the drum walls.

A corresponding principle in accordance with the embodiment of claim 8 relates to the surfaces of the door leaves which are covered with a vertical or horizontal grid of photoelectric barriers. Thus, when a person will stick any object onto the door leaf (or its cabinet), these objects can be detected.

Finally, the embodiment according to claim 9 proposes that vertical photoelectric barriers are used on the outer drum edge in order to detect objects that could be thrown by persons into the revolving door.

One embodiment of the revolving door according to the invention will be explained in the following with the aid of the drawings. It is shown in:

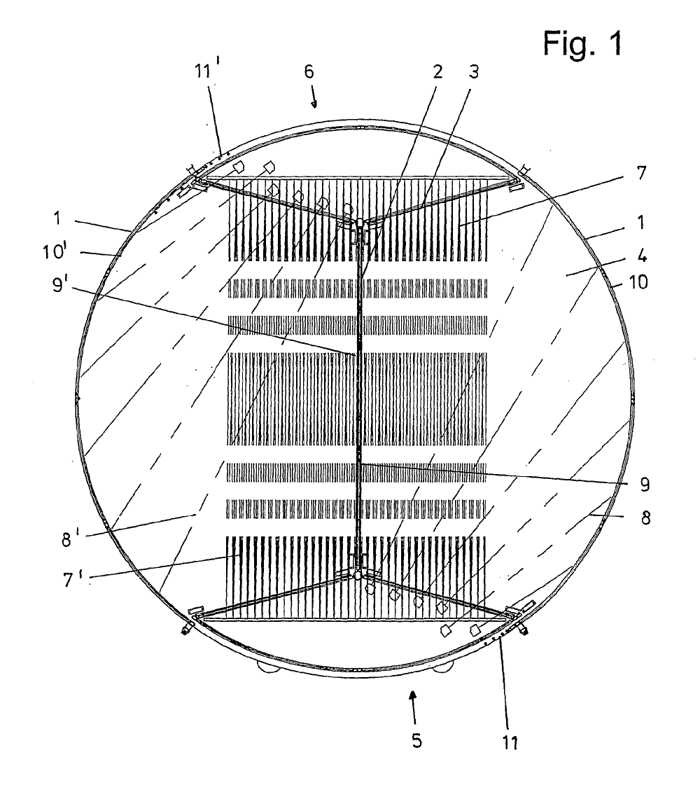

FIG. 1 a horizontal section of a revolving door in the closed position;

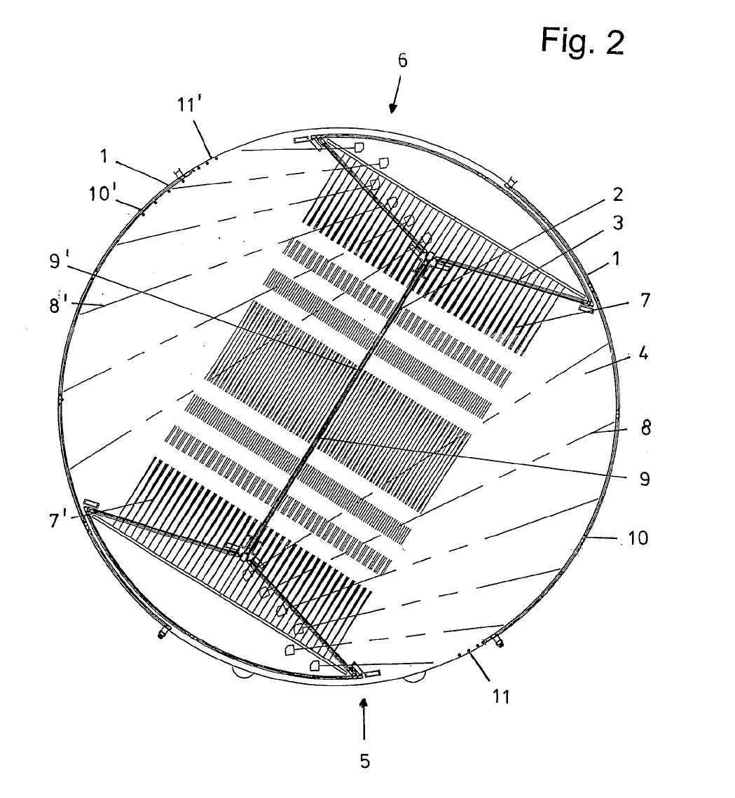

FIG. 2 an illustration in accordance with FIG. 1 in the half-open position;

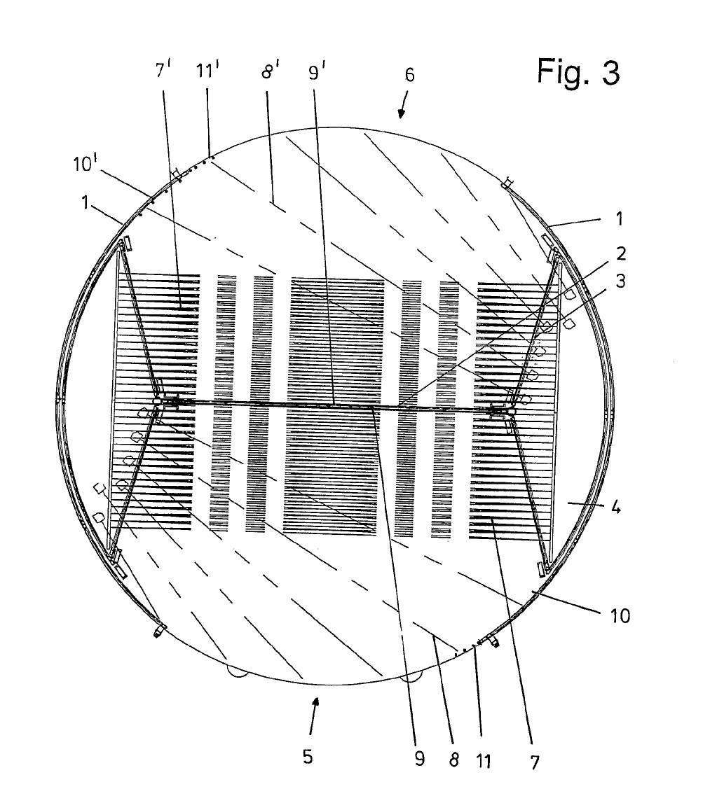

FIG. 3 a representation in accordance with FIG. 1 of the fully open position.

The revolving door has two drum walls 1 in the form of cylinder wall segments that are positioned diametrically opposed to one another. At the center of the two drum walls two door leaves 2 are supported so as to be rotatable about a vertical central axis. The radial ends of the two door leaves 2 have transverse leaves 3 that are embodied as display cabinets. Finally, the revolving door also has a floor 4 as well as a ceiling.

The revolving door is provided with the conventional devices for safe operation, for example, sensors that are to prevent that persons become pinched between the drum walls 1 and the door leaves 2.

Primarily, the revolving door has however a special sensor system for detecting whether a person has thrown something onto the floor 4 or has stuck something to the inner wall of the drum walls 1, the door leaves 2 or the ceiling.

In the illustrated embodiment, the so-called unsecured side and the so-called secured side are illustrated at the bottom end and the top end in the drawings, respectively. This means that the revolving door defines a type of lock by means of which persons from the unsecured side reach the secured side, for example, within a building. In the drawings at the bottom end the entry opening 5 and at the top end the exit opening 6 are located.

The special sensor system monitors only those areas within the revolving door through which no person or no objects can pass from the unsecured side to the secured side.

The special sensor system has a system of photoelectric barriers.

A first grid comprised of photoelectric barriers 7, 7′ with parallel aligned light beams is formed between the two transverse leaves 3 of the door leaves 2, that is in the area of the floor 4, on the one hand, and in the area of the ceiling, on the other hand.

A second system of photoelectric barriers 8, 8′ (also in the area of the floor 4 as well as in the area of the ceiling) extends from the transverse leaves 3 of the door leaves 2 and radiates in the direction of the inner side of the drum walls 1. The light beams are designed to diverge.

Moreover, grids of photoelectric barriers 9, 9′ are provided in the area of the surfaces of the door leaves 2 as well as their transverse leaves 3. These grids can be oriented vertically or horizontally. This photoelectric barriers 9, 9′ are located also in the area of the vertical stays between the door leaves 2 and the transverse leaves 3.

The inner surfaces of the drum walls 1 have a vertical grid of laser light barriers 10, 10′.

Finally, photoelectric barriers 11, 11′ in the area of the entry opening 5 as well as the exit opening 6 in the vicinity of the drum walls 1 are provided.

The operation is as follows:

FIG. 1 shows the closed revolving door in the initial position. The photoelectric barriers 7-11 are activated while the photoelectric barriers 7′-11′ are inactive.

FIG. 2 shows the situation when the door leaves 2 with their transverse leaves 3 have been rotated farther so that the entry opening 5 as well as the exit opening 6 are partially open. The photoelectric barriers 7-11 are still active and the photoelectric barriers 7′-11′ inactive.

When a person coming from the unsecured side throws something on the floor 4 or sticks something to the door leaves 2 or the drum walls 1 or the ceiling, this is detected by the active photoelectric barriers 7-10 and a corresponding alarm is triggered. The same holds true for the photoelectric barriers 11 in the area of the entry opening 5 when a person attempts to throw something into the revolving door. The photoelectric barriers 7-10 are designed such that all inner surfaces in the revolving door are monitored. Since the photoelectric barriers 8 are designed to diverge and are oriented toward the inner side of the drum walls 1, they scan the entire floor 4 as well as the entire ceiling.

Finally, FIG. 3 shows the situation when the entry opening 5 and the exit opening 6 are completely open. In this case, the photoelectric barriers on one side are active while the photoelectric barriers 7′-11′ are inactive.

When the revolving door rotates farther and the 180 degree position of the door leaves 2 in comparison to the initial position of FIG. 1 is reached, the photoelectric barriers 7-11 will become inactive and the photoelectric barriers 7′-11′ will become active. This means that the area where the persons who want to move from the lower unsecured side to the upper secured side are located is now monitored.

Moreover, contact mats—not illustrated—can be provided. They serve as a one-way traffic control. They prevent that persons can pass from the unsecured side to the secured side.

Special electronic monitoring modules register moreover any impact, for example, of objects; this can trigger an additional alarm and therefore can improve security.

### LIST OF REFERENCE NUMERALS

1 drum walls

2 door leaf

3 transverse leaf

4 floor

5 entry opening

6 exit opening

7, 7′ photoelectric barriers

8, 8′ photoelectric barriers

9, 9′ photoelectric barriers

10, 10′ photoelectric barriers

11, 11′ photoelectric barriers

What is claimed is:

1.-9. (canceled)

10. Revolving door comprising:
two opposed concentric drum walls of a cylindrical segment shape;
door leaves rotatable about a central axis;
a floor connected to the drum walls;
a ceiling connected to the drum walls;
sensors monitoring completely or partially at least one surface of an inner wall of the drum walls; the door leaves; the floor; and the ceiling with regard to whether an object is located on or at said at least one surface.

11. Revolving door according to claim 10, wherein only those areas within the revolving door are monitored by the sensors in which areas a person passes from an unsecured side to a secured side through the revolving door.

12. Revolving door according to claim 10, wherein the sensors are photoelectric barriers.

13. Revolving door according to claim 12, wherein the door leaves each have radially outwardly a transverse leaf and a grid of the photoelectric barriers is provided between the transverse leaves in the area of the floor and/or in the area of the ceiling.

14. Revolving door according to claim 12, wherein the photoelectric barriers extend from the door leaves in the area of the floor and/or in the area of the ceiling toward the inner wall of the drum walls.

15. Revolving door according to claim 14, wherein light beams emitted by the photoelectric barriers diverge.

16. Revolving door according to claim 12, wherein the inner walls of the drum walls each are covered at least partially with a vertical grid of the photoelectric barriers.

17. Revolving door according to claim 12, wherein the surfaces of the door leaves are covered at least partially with a vertical or horizontal grid of the photoelectric barriers.

18. Revolving door according to claim 12, wherein between the drum walls an entry opening and an exit opening are provided, wherein at least at one of the entry opening and the exit opening at least partially a vertical grid of the photoelectric barriers is provided.
